(19) United States
(12) Patent Application Publication
(10) Pub. No.: US 2023/0196703 A1
(43) Pub. Date: Jun. 22, 2023

(54) TERMINAL APPARATUS, METHOD OF OPERATING TERMINAL APPARATUS, AND SYSTEM

(71) Applicant: TOYOTA JIDOSHA KABUSHIKI KAISHA, Aichi-ken (JP)

(72) Inventors: Wataru KAKU, Tokyo-to (JP); Mina KUNAZUKURI, Tokyo-to (JP)

(73) Assignee: TOYOTA JIDOSHA KABUSHIKI KAISHA, Aichi-ken (JP)

(21) Appl. No.: 18/068,201

(22) Filed: Dec. 19, 2022

(30) Foreign Application Priority Data
Dec. 21, 2021 (JP) 2021-207480

(51) Int. Cl. G06T 19/20; G10L 15/22

(52) U.S. Cl. CPC G06T 19/20; G10L 15/22; G06T 2219/2016

(57) ABSTRACT

A terminal apparatus includes a communication interface and a controller configured to communicate using the communication interface. The controller is configured to receive, from another terminal apparatus, information for generating a 3D model that represents a participant who participates in an event in a virtual space using the other terminal apparatus, generate the 3D model to have a size corresponding to an amount of speech of the participant in the event, and output information for displaying an image obtained by rendering the virtual space in which the 3D model is placed.

### CROSS-REFERENCE TO RELATED APPLICATION

This application claims priority to Japanese Patent Application No. 2021-207480, filed on Dec. 21, 2021, the entire contents of which are incorporated herein by reference.

### TECHNICAL FIELD

The present disclosure relates to a terminal apparatus, a method of operating a terminal apparatus, and a system.

### BACKGROUND

A method is known for computers at multiple points to communicate via a network and hold meetings in a virtual space on the network. Various forms of technology have been proposed to improve the convenience of participants in such meetings on the network. For example, Patent Literature (PTL) 1 discloses a system that distinguishes between the image of a participant who has the right to speak and the images of other participants among the images of meeting participants displayed on each computer.

### CITATION LIST

### Patent Literature

PTL 1: JP H8-331534 A

### SUMMARY

There is room for improvement in the convenience for participants in events in a virtual space on the network.

It would be helpful to provide a terminal apparatus and the like that contribute to the convenience for participants in events in a virtual space.

A terminal apparatus according to the present disclosure includes:
a communication interface; and
a controller configured to communicate using the communication interface, wherein
the controller is configured to receive, from another terminal apparatus, information for generating a 3D model that represents a participant who participates in an event in a virtual space using the other terminal apparatus, generate the 3D model to have a size corresponding to an amount of speech of the participant in the event, and output information for displaying an image obtained by rendering the virtual space in which the 3D model is placed.

A method of operating a terminal apparatus according to the present disclosure is a method of operating a terminal apparatus including a communication interface and a controller configured to communicate using the communication interface, the method including:

receiving, by the controller, from another terminal apparatus, information for generating a 3D model that represents a participant who participates in an event in a virtual space using the other terminal apparatus, generating the 3D model to have a size corresponding to an amount of speech of the participant in the event, and outputting information for displaying an image obtained by rendering the virtual space in which the 3D model is placed.

A system according to the present disclosure is a system including a plurality of terminal apparatuses configured to communicate via a server apparatus, wherein
a first terminal apparatus transmits information for generating a 3D model that represents a participant who participates in an event in a virtual space using the first terminal apparatus, and
a second terminal apparatus receives the information from the first terminal apparatus, generates the 3D model to have a size corresponding to an amount of speech of the participant in the event, and outputs information for displaying an image obtained by rendering the virtual space in which the 3D model is placed.

The terminal apparatus and the like according to the present disclosure can contribute to the convenience for participants in events in a virtual space.

### BRIEF DESCRIPTION OF THE DRAWINGS

In the accompanying drawings:

FIG. 1 is a diagram illustrating an example configuration of a virtual event provision system;

FIG. 2 is a sequence diagram illustrating an example of operations of the virtual event provision system;

FIG. 3A is a flowchart illustrating an example of operations of a terminal apparatus;

FIG. 3B is a flowchart illustrating an example of operations of a terminal apparatus;

FIG. 4 is a diagram illustrating an example of the correspondence between the amount of speech and the size of a 3D model;

FIG. 5A is a diagram illustrating an example of a virtual space image;

FIG. 5B is a diagram illustrating an example of a virtual space image;

FIG. 5C is a diagram illustrating an example of a virtual space image; and

FIG. 5D is a diagram illustrating an example of a virtual space image.

### DETAILED DESCRIPTION

Embodiments are described below.

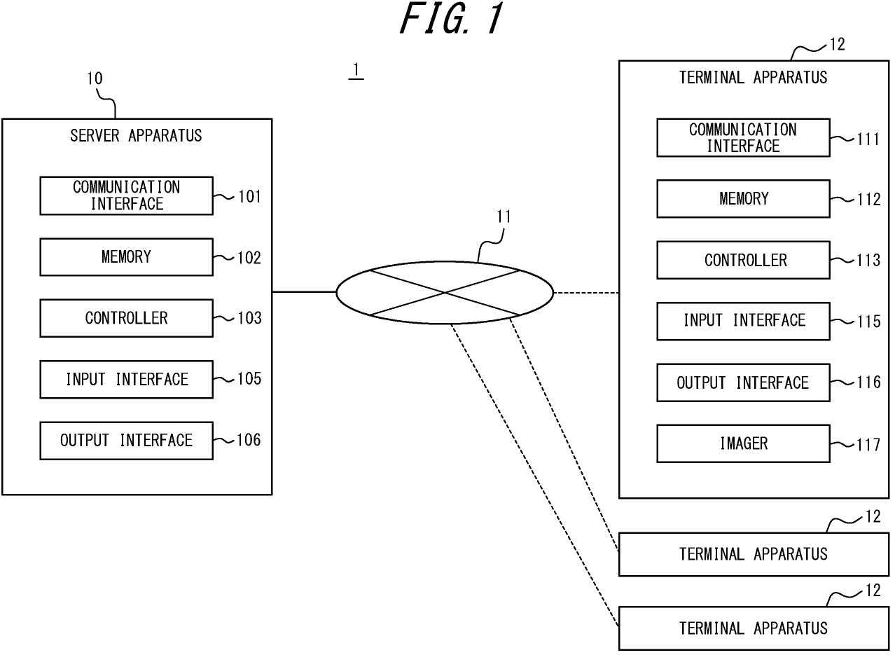

FIG. 1 is a diagram illustrating an example configuration of a virtual event provision system 1 in an embodiment. The virtual event provision system 1 includes a plurality of terminal apparatuses 12 and a server apparatus 10 that are communicably connected to each other via a network 11. The virtual event provision system 1 is a system for providing events in a virtual space, i.e., virtual events, in which users can participate using the terminal apparatuses 12. A virtual event is an event in which a plurality of participants communicates information by speech or the like in a virtual space, and each participant is represented by a 3D model. The event in the present embodiment is a discussion among participants on any topic.

The server apparatus 10 is, for example, a server computer that belongs to a cloud computing system or other computing system and functions as a server that implements various functions. The server apparatus 10 may be configured by two or more server computers that are communicably connected to each other and operate in cooperation. The server apparatus 10 transmits and receives, and performs information processing on, information necessary to provide virtual events.

Each terminal apparatus 12 is an information processing apparatus provided with communication functions and is used by a user (participant) who participates in a virtual event provided by the server apparatus 10. The terminal apparatus 12 is, for example, an information processing terminal, such as a smartphone or a tablet terminal, or an information processing apparatus, such as a personal computer.

The network 11 may, for example, be the Internet or may include an ad hoc network, a Local Area Network (LAN), a Metropolitan Area Network (MAN), other networks, or any combination thereof.

In the present embodiment, the terminal apparatus 12 includes a communication interface 111 and a controller 113. The controller 113 receives, from another terminal apparatus 12, information for generating a 3D model that represents a participant who participates in an event in a virtual space using the other terminal apparatus 12, generates the 3D model to have a size corresponding to an amount of speech by the participant in the event, and outputs information for displaying an image obtained by rendering the virtual space in which the 3D model is placed. By the size of the 3D model representing a participant being changed according to the amount of speech of the participant, each participant in the virtual event can visually recognize the relative amount of speech of each participant, and participants with a small amount of amount of speech are encouraged to speak more actively. This can contribute to the convenience for participants.

Respective configurations of the server apparatus 10 and the terminal apparatuses 12 are described in detail.

The server apparatus 10 includes a communication interface 101, a memory 102, a controller 103, an input interface 105, and an output interface 106. These configurations are appropriately arranged on two or more computers in a case in which the server apparatus 10 is configured by two or more server computers.

The communication interface 101 includes one or more interfaces for communication. The interface for communication is, for example, a LAN interface. The communication interface 101 receives information to be used for the operations of the server apparatus 10 and transmits information obtained by the operations of the server apparatus 10. The server apparatus 10 is connected to the network 11 by the communication interface 101 and communicates information with the terminal apparatuses 12 via the network 11.

The memory 102 includes, for example, one or more semiconductor memories, one or more magnetic memories, one or more optical memories, or a combination of at least two of these types, to function as main memory, auxiliary memory, or cache memory. The semiconductor memory is, for example, Random Access Memory (RAM) or Read Only Memory (ROM). The RAM is, for example, Static RAM (SRAM) or Dynamic RAM (DRAM). The ROM is, for example, Electrically Erasable Programmable ROM (EEPROM). The memory 102 stores information to be used for the operations of the server apparatus 10 and information obtained by the operations of the server apparatus 10.

The controller 103 includes one or more processors, one or more dedicated circuits, or a combination thereof. The processor is a general purpose processor, such as a central processing unit (CPU), or a dedicated processor, such as a graphics processing unit (GPU), specialized for a particular process. The dedicated circuit is, for example, a field-programmable gate array (FPGA), an application specific integrated circuit (ASIC), or the like. The controller 103 executes information processing related to operations of the server apparatus 10 while controlling components of the server apparatus 10.

The input interface 105 includes one or more interfaces for input. The interface for input is, for example, a physical key, a capacitive key, a pointing device, a touch screen integrally provided with a display, or a microphone that receives audio input. The input interface 105 accepts operations to input information used for operation of the server apparatus 10 and transmits the inputted information to the controller 103.

The output interface 106 includes one or more interfaces for output. The interface for output is, for example, a display or a speaker. The display is, for example, a liquid crystal display (LCD) or an organic electro-luminescent (EL) display. The output interface 106 outputs information obtained by the operations of the server apparatus 10.

The functions of the server apparatus 10 are realized by a processor included in the controller 103 executing a control program. The control program is a program for causing a computer to function as the server apparatus 10. Some or all of the functions of the server apparatus 10 may be realized by a dedicated circuit included in the controller 103. The control program may be stored on a non-transitory recording/storage medium readable by the server apparatus 10 and be read from the medium by the server apparatus 10.

Each terminal apparatus 12 includes a communication interface 111, a memory 112, a controller 113, an input interface 115, an output interface 116, and an imager 117.

The communication interface 111 includes a communication module compliant with a wired or wireless LAN standard, a module compliant with a mobile communication standard such as LTE, 4G, or 5G, or the like. The terminal apparatus 12 connects to the network 11 via a nearby router apparatus or mobile communication base station using the communication interface 111 and communicates information with the server apparatus 10 and the like over the network 11.

The memory 112 includes, for example, one or more semiconductor memories, one or more magnetic memories, one or more optical memories, or a combination of at least two of these types. The semiconductor memory is, for example, RAM or ROM. The RAM is, for example, SRAM or DRAM. The ROM is, for example, EEPROM. The memory 112 functions as, for example, a main memory, an auxiliary memory, or a cache memory. The memory 112 stores information to be used for the operations of the controller 113 and information obtained by the operations of the controller 113.

The controller 113 has one or more general purpose processors such as CPUs or Micro Processing Units (MPUs) or one or more dedicated processors, such as GPUs, that are dedicated to specific processing. Alternatively, the controller 113 may have one or more dedicated circuits such as FPGAs or ASICs. The controller 113 is configured to perform overall control of the operations of the terminal apparatus 12 by operating according to the control/processing programs or operating according to operation procedures implemented in the form of circuits. The controller 113 then transmits and receives various types of information to and from the server apparatus 10 and the like via the communication interface 111 and executes the operations according to the present embodiment.

The input interface 115 includes one or more interfaces for input. The interface for input may include, for example, a physical key, a capacitive key, a pointing device, and/or a touch screen integrally provided with a display. The interface for input may also include a microphone that accepts audio input and a camera that captures images. The interface for input may further include a scanner, camera, or IC card reader that scans an image code. The input interface 115 accepts operations for inputting information to be used in the operations of the controller 113 and transmits the inputted information to the controller 113.

The output interface 116 includes one or more interfaces for output. The interface for output may include, for example, a display or a speaker. The display is, for example, an LCD or an organic EL display. The output interface 116 outputs information obtained by the operations of the controller 113.

The imager 117 includes a camera that captures an image of a subject using visible light and a distance measuring sensor that measures the distance to the subject to acquire a distance image. The camera captures a subject at, for example, 15 to 30 frames per second to produce a moving image formed by a series of captured images. Distance measurement sensors include ToF (Time Of Flight) cameras, LiDAR (Light Detection And Ranging), and stereo cameras and generate distance images of a subject that contain distance information. The imager 117 transmits the captured images and the distance images to the controller 113.

The functions of the controller 113 are realized by a processor included in the controller 113 executing a control program. The control program is a program for causing the processor to function as the controller 113. Some or all of the functions of the controller 113 may be realized by a dedicated circuit included in the controller 113. The control program may be stored on a non-transitory recording/storage medium readable by the terminal apparatus 12 and be read from the medium by the terminal apparatus 12.

In the present embodiment, the controller 113 acquires captured images and distance images of the user of the terminal apparatus 12, i.e., the participant, using the imager 117 and collects audio of the participant’s speech using the microphone of the input interface 115. The controller 113 encodes the captured image and distance image of the participant, which are for generating a 3D model of the participant, and audio information, which is for reproducing the participant’s speech, to generate encoded information. The controller 113 may perform any appropriate processing (such as resolution change and trimming) on the captured images and the like at the time of encoding. The controller 113 uses the communication interface 111 to transmit the encoded information to the other terminal apparatus 12 via the server apparatus 10. The controller 113 also receives encoded information, transmitted from the other terminal apparatus 12 via the server apparatus 10, using the communication interface 111. Upon decoding the encoded information received from the other terminal apparatus 12, the controller 113 uses the decoded information to generate a 3D model representing the participant who uses the other terminal apparatus 12 (other participant) and places the 3D model in the virtual space. The controller 113 also further uses the captured image and distance image of the participant to generate a 3D model of the participant and place the 3D model in the virtual space. In generating the 3D model, the controller 113 generates a polygon model using the distance images of the other participant and applies texture mapping to the polygon model using the captured image of the other participant, thereby generating the 3D model of each participant. This example is not limiting, however, and any appropriate method can be used to generate the 3D model. When the controller 113 generates virtual space images for output by rendering, the virtual space image including a 3D model from a predetermined viewpoint in the virtual space, the output interface 116 displays the virtual space images and outputs speech of the other participant based on the audio information for the other participant. These operations of the controller 113 and the like enable the participant of the terminal apparatus 12 to participate in the virtual event and talk with other participants in real time.

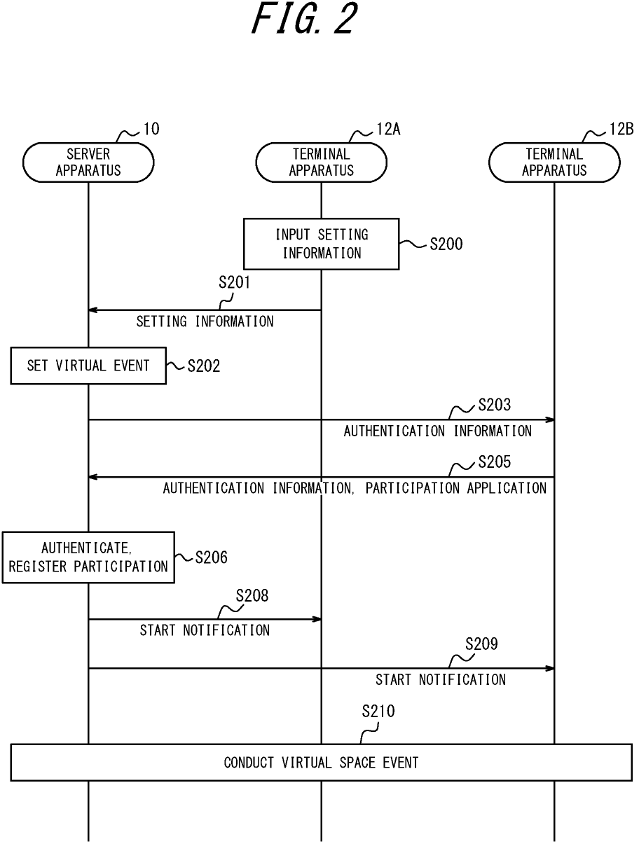

FIG. 2 is a sequence diagram illustrating the operating procedures of the virtual event provision system 1. This sequence diagram illustrates the steps in the coordinated operation of the server apparatus 10 and the plurality of terminal apparatuses 12 (referred to as the terminal apparatus 12A and 12B when distinguishing therebetween). The terminal apparatus 12A is used by the administrator/participant (participant A) of the virtual event. The terminal apparatus 12B is used by a participant other than the administrator (participant B). In a case of inviting a plurality of participants B participating using respective terminal apparatuses 12B, the operating procedures for the terminal apparatus 12B illustrated here are performed by each terminal apparatus 12B, or by each terminal apparatus 12B and the server apparatus 10.

The steps pertaining to the various information processing by the server apparatus 10 and the terminal apparatuses 12 in FIG. 2 are performed by the respective controllers 103 and 113. The steps pertaining to transmitting and receiving various types of information to and from the server apparatus 10 and the terminal apparatuses 12 are performed by the respective controllers 103 and 113 transmitting and receiving information to and from each other via the respective communication interfaces 101 and 111. In the server apparatus 10 and the terminal apparatuses 12, the respective controllers 103 and 113 appropriately store the information that is transmitted and received in the respective memories 102 and 112. Furthermore, the controller 113 of the terminal apparatus 12 accepts input of various types of information with the input interface 115 and outputs various types of information with the output interface 116.

In step S200, the terminal apparatus 12A accepts input of virtual event setting information by participant A. The setting information includes the schedule of the virtual event, the topic for discussion, a list of participants, and the like. The list of participants includes each participant’s name and e-mail address. Here, participant B is included in the list of participants. In step S201, the terminal apparatus 12A then transmits the setting information to the server apparatus 10. The server apparatus 10 receives the information transmitted from the terminal apparatus 12A. For example, the terminal apparatus 12A accesses a site provided by the server apparatus 10 for conducting a virtual event, acquires an input screen for setting information, and displays the input screen to participant A. Then, once participant A inputs the setting information on the input screen, the setting information is transmitted to the server apparatus 10.

In step S202, the server apparatus 10 sets up a virtual event based on the setting information. The controller 103 stores information on the virtual event and information on the expected participants in association in the memory 102.

In step S203, the server apparatus 10 transmits authentication information to the terminal apparatus 12B. The authentication information is information used to identify and authenticate participant B who uses the terminal apparatus 12B, i.e., information such as an ID and passcode used when participating in a virtual event. Such information is, for example, transmitted as an e-mail attachment. The terminal apparatus 12B receives the information transmitted from the server apparatus 10.

In step S205, the terminal apparatus 12B transmits the authentication information received from the server apparatus 10 and information on a participation application to the server apparatus 10. Participant B operates the terminal apparatus 12B and applies to participate in the virtual event using the authentication information transmitted by the server apparatus 10. For example, the terminal apparatus 12B accesses the site provided by the server apparatus 10 for the virtual event, acquires the input screen for the authentication information and the information on the participation application, and displays the input screen to participant B. The terminal apparatus 12B then accepts the information inputted by participant B and transmits the information to the server apparatus 10.

In step S206, the server apparatus 10 performs authentication on participant B, thereby completing registration for participation. The identification information for the terminal apparatus 12B and the identification information for participant B are stored in association in the memory 102.

In steps S208 and S209, the server apparatus 10 transmits an event start notification to the terminal apparatuses 12A and 12B. Upon receiving the information transmitted from the server apparatus 10, the terminal apparatuses 12A and 12B begin the imaging and collection of audio of speech for participant A and participant B, respectively.

In step S210, a virtual event is conducted by the terminal apparatuses 12A and 12B via the server apparatus 10. The terminal apparatus 12A and 12B transmit and receive information for generating 3D models representing participant A and participant B, respectively, and information on speech to each other via the server apparatus 10. The terminal apparatuses 12A and 12B output images of the virtual event, including the 3D models of the participants, and speech of the other participant to participant A and participant B, respectively.

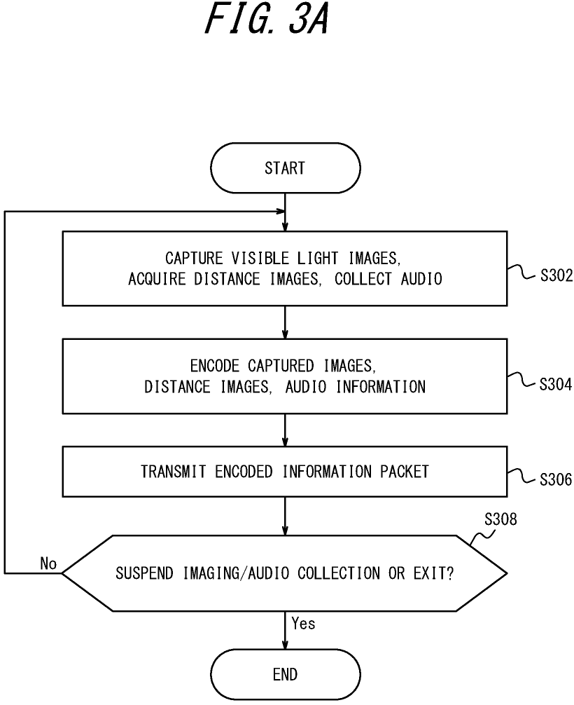

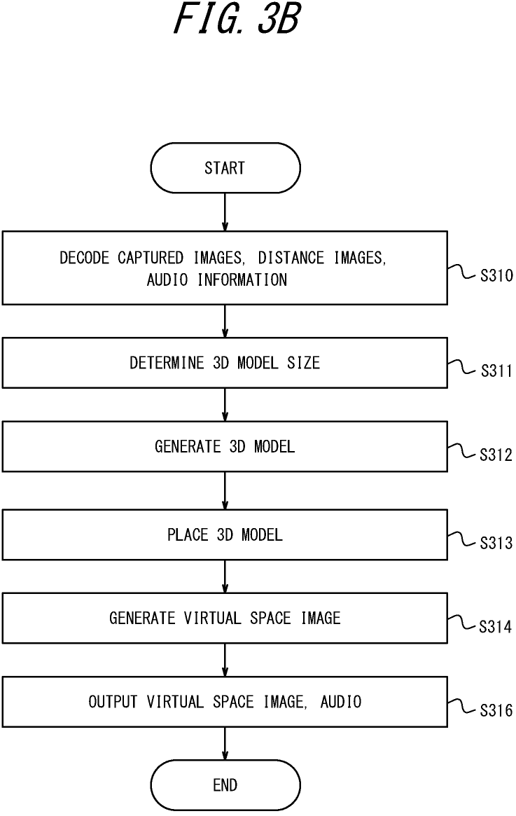

FIGS. 3A and 3B are flowcharts illustrating the operating procedures of the terminal apparatus 12 for conducting a virtual event. The procedures illustrated here are common to the terminal apparatuses 12A and 12B and are described without distinguishing between the terminal apparatuses 12A and 12B.

FIG. 3A relates to the operating procedures of the controller 113 when each terminal apparatus 12 transmits information for generating a 3D model of the participant who uses that terminal apparatus 12.

In step S302, the controller 113 captures visible light images and acquires distance images of the participant at an appropriately set frame rate using the imager 117 and collects audio of the participant’s speech using the input interface 115. The controller 113 acquires the images captured by visible light and the distance images from the imager 117 and the audio information from the input interface 115.

In step S304, the controller 113 encodes the captured image, the distance image, and the audio information to generate encoded information.

In step S306, the controller 113 converts the encoded information into packets using the communication interface 111 and transmits the packets to the server apparatus 10 for the other terminal apparatus 12.

When information inputted for an operation by the participant to suspend imaging and collection of audio or to exit the virtual event is acquired (Yes in S308), the controller 113 terminates the processing procedure in FIG. 3A, whereas while not acquiring information corresponding to an operation to suspend or exit (No in S308), the controller 113 executes steps S302 to S306 and transmits, to the other terminal apparatus 12, information for generating a 3D model representing the participant and information for outputting audio.

FIG. 3B relates to the operating procedures of the controller 113 when the terminal apparatus 12 outputs an image of the virtual event and audio of the other participant. Upon receiving, via the server apparatus 10, a packet transmitted by the other terminal apparatus 12 performing the procedures in FIG. 3A, the controller 113 performs steps S310 to S313. Also, upon acquiring the captured image, distance image, and speech of the participant, the controller 113 performs steps S310 to S313.

In step S310, the controller 113 decodes the encoded information included in the packet received from the other terminal apparatus 12 to acquire the captured image, distance image, and audio information. When performing step S302, the controller 113 acquires the captured image and distance image of the participant from the imager 117 and the audio information from the input interface 115.

In step S311, the controller 113 determines the size of the 3D model of each participant, i.e., the participant and the other participants, based on the amount of speech of that participant. The amount of speech is, for example, the total speaking time during the most recent determination period (for example, several seconds to several minutes). The controller 113 detects sounds that are in the frequency band to which human speech sounds belong (for example, 100 Hz to 1000 Hz) and are above an appropriate reference sound pressure as speech. The controller 113 may distinguish speech that matches a preset language from other noise through speech recognition. The controller 113 derives the amount of speech by accumulating the time that speech is detected during the determination period. The controller 113 then determines the size of the 3D model corresponding to the amount of speech for each determination period.

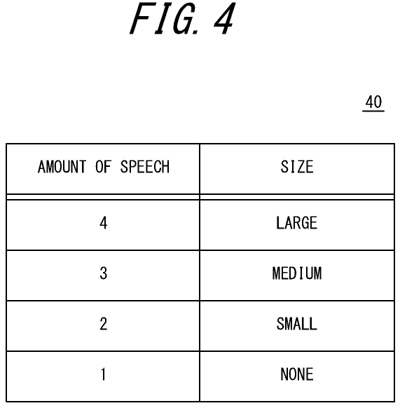

FIG. 4 illustrates an example of the correspondence between amount of speech and size. A table 40 that associates amounts of speech with sizes, for example, is stored in the memory 112. The amount of speech is, for example, divided by an appropriate criterion into four levels, “4”, “3”, “2”, and “1” from largest to smallest. The levels are associated with four respective sizes of the 3D model, “large”, “medium”, “small”, and “none”. The size is the proportion of the virtual space image occupied by the 3D model when the generated 3D model is placed in the virtual space and the virtual space image is rendered. Here, the 3D model of each participant is assumed to be generated based on an appropriately set “medium” size, regardless of differences in actual dimensions among participants. The “large” and “small” sizes are sizes yielded by respectively enlarging and reducing the “medium” size by an appropriate ratio set in advance. Since the “large” size is the upper limit, regardless of how much the amount of speech increases, extreme imbalances in size among the 3D models can be avoided. Alternatively, so that differences in actual dimensions are reflected in the size of the 3D model, each size can be corrected by an appropriate coefficient or the like within a range that does not reverse the differences among sizes. The size “none” means that the 3D model is hidden. The controller 113 refers to this table 41 to determine the size of the 3D model corresponding to the derived amount of speech.

In step S312, the controller 113 generates a 3D model representing each participant based on the captured image and the distance image. The controller 113 generates the 3D model representing the corresponding participant or other participant to have the size determined in step S311. The controller 113 stops generation of a 3D model determined to be of size “none”.

In a case of receiving information from a plurality of other participants’ terminal apparatuses 12, the controller 113 performs steps S310 to S312 for each of the other terminal apparatuses 12 and generates or stops generation of the 3D model for each of the other participants, depending on the size.

In step S313, the controller 113 places the 3D model representing each participant in the virtual space where the virtual event is held. The memory 112 stores, in advance, information on the coordinates of the virtual space and the coordinates at which the 3D models should be placed according to the order in which the participants are authenticated, for example. The controller 113 places the generated 3D models at the coordinates in the virtual space corresponding to the role of the participant and the other participants.

In step S314, the controller 113 renders and generates a virtual space image in which the plurality of 3D models placed in the virtual space are captured from a virtual viewpoint. Here, a 3D model determined to have the size “none” is not generated, and therefore the 3D model is hidden.

In step S316, the controller 113 displays the virtual space image and outputs audio using the output interface 116. In other words, the controller 113 outputs information to the output interface 116 for displaying images of an event in which 3D models are placed in a virtual space, and the output interface 116 displays the virtual space images and outputs audio.

As a variation, in step S316, the controller 113 may mute the speech in a case in which the participant corresponding to the hidden 3D model speaks, perform speech recognition processing on the speech, generate text corresponding to the speech, and display the text in the virtual space image.

By the controller 113 repeatedly executing steps S310 to S316, the participant can listen to the speech of another participant while watching a video of virtual space images that include a 3D model of the other participant. At this time, as each participant’s amount of speech changes, the corresponding 3D models are generated and displayed in different sizes.

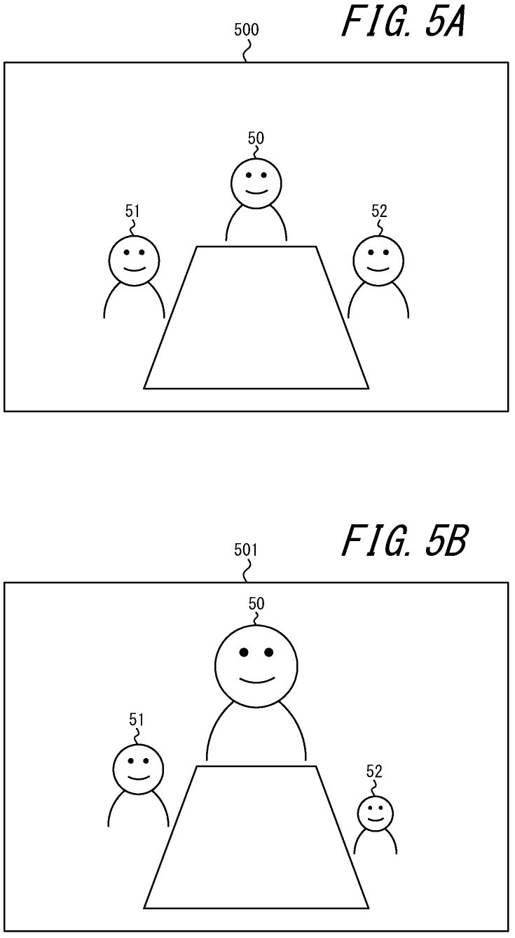

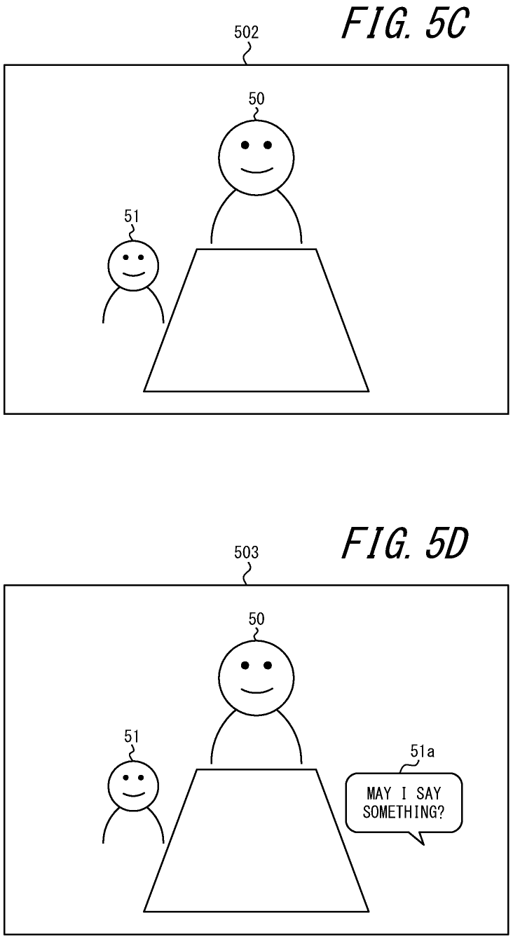

FIGS. 5A to 5D illustrate examples of virtual space images. Here, the 3D model is displayed schematically in a simplified manner.

FIG. 5A illustrates a virtual space image 500 including 3D models 50 to 52 representing participants in a business meeting or the like. The virtual space image 500 is an example of a case in which the 3D models 50 to 52 are all generated and displayed to have a “medium” size. The controller 113 may generate each 3D model to have a “medium” size, as in the virtual space image 500, until an appropriate length of time (for example, several minutes) has elapsed from the start of the virtual event.

The virtual space image 501 in FIG. 5B is an example of a case in which 3D models 50 to 51 are generated and displayed to have the sizes “large”, “medium”, and “small”, respectively, due to the participant’s amount of speech corresponding to 3D models 50 to 51 being determined to be “4”, “3”, and “2” in table 40 in FIG. 4. Here, by the size “large” being set as the upper limit, an extreme imbalance in size among the 3D models can be avoided.

The virtual space image 502 in FIG. 5C is an example of a case in which the 3D model 51 is generated with size “none”, i.e., is hidden, because the participant’s amount of speech corresponding to the 3D model 51 is determined to be “1”.

The virtual space image 503 in FIG. 5D is an example of a case in which the speech of a participant corresponding to the hidden 3D model 51 is displayed as text 51a instead of being outputted as audio. When the participant corresponding to the hidden 3D model 51 speaks and the amount of speech is determined to be “2” or more, the 3D model 51 is displayed to have a size corresponding to the amount of speech, but the speech until that point is displayed by the text 51a. In addition to the participant’s own 3D model being hidden, the participant can see that his or her speech is displayed by the text 51a and can recognize the need to speak actively.

In this way, the visual recognition of a 3D model whose size corresponds to the participant’s amount of speech makes it easier to focus attention on participants with a high amount of speech, whereas participants with a low amount of speech are encouraged to speak more actively. In this case, hiding the 3D model or muting and displaying the speech as text can encourage participants with a low amount of speech to speak actively. This can contribute to the convenience for participants.

In a variation of the present embodiment, when the server apparatus 10 relays audio information from each terminal apparatus 12, the server apparatus 10 may perform a process equivalent to step S311 in FIG. 3B to determine the size of the 3D model. For example, the table 40 illustrated in FIG. 4 is stored in the memory 102 of the server apparatus 10, and the controller 103 decodes the encoded information received from the terminal apparatus 12 to acquire audio information and uses the table 40 to determine the size of the 3D model corresponding to the amount of speech of the participant who uses the terminal apparatus 12. The controller 103 then transmits the encoded information along with size information to the destination terminal apparatus 12. The terminal apparatus 12 then omits step S311 and generates the 3D model using the acquired size information. These procedures can be adopted according to the processing performance and communication speed of the processors in the server apparatus 10 and the terminal apparatus 12 so as to distribute the load among the apparatuses.

An example of the amount of speech and the size being divided into four levels has been described, but the number of levels is not limited to this example. The number of levels of the amount of speech does not have to match the number of levels of size. A plurality of levels of the amount of speech may correspond to one level of the size, or a plurality of sizes may correspond to one level of the amount of speech. Alternatively, the controller 113 or 103 may derive the level corresponding to the amount of speech by any appropriate conversion formula or the like. The amount of speech at which the 3D model is hidden and the amount of speech at which the audio is muted may be different. For example, the controller 113 or 103 may hide the 3D model of a participant with a low amount of speech but output the audio, and when the amount of speech decreases further, the controller 113 or 103 may mute the audio and display text indicating the speech.

While embodiments have been described with reference to the drawings and examples, it should be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

1. A terminal apparatus comprising:
a communication interface; and
a controller configured to communicate using the communication interface, wherein
the controller is configured to receive, from another terminal apparatus, information for generating a 3D model that represents a participant who participates in an event in a virtual space using the other terminal apparatus, generate the 3D model to have a size corresponding to an amount of speech of the participant in the event, and output information for displaying an image obtained by rendering the virtual space in which the 3D model is placed.

2. The terminal apparatus according to claim 1, wherein the controller is configured to generate the 3D model to have a first size for a first amount of speech and to have a second size that is larger than the first size for a second amount of speech that is larger than the first amount of speech.

3. The terminal apparatus according to claim 1, wherein the controller is configured to hide the 3D model in the image when the amount of speech is equal to or less than a first reference.

4. The terminal apparatus according to claim 1, wherein the controller is configured to output audio information for outputting audio of the speech when the amount of speech is equal to or greater than a second reference and stop outputting the audio information when the amount of speech is less than the second reference.

5. The terminal apparatus according to claim 4, wherein the controller is configured to output information for displaying information indicating the speech of the participant when the controller has stopped outputting the audio information.

6. A method of operating a terminal apparatus comprising a communication interface and a controller configured to communicate using the communication interface, the method comprising:
receiving, by the controller, from another terminal apparatus, information for generating a 3D model that represents a participant who participates in an event in a virtual space using the other terminal apparatus, generating the 3D model to have a size corresponding to an amount of speech of the participant in the event, and outputting information for displaying an image obtained by rendering the virtual space in which the 3D model is placed.

7. The method according to claim 6, wherein the controller generates the 3D model to have a first size for a first amount of speech and to have a second size that is larger than the first size for a second amount of speech that is larger than the first amount of speech.

8. The method according to claim 6, wherein the controller hides the 3D model in the image when the amount of speech is equal to or less than a first reference.

9. The method according to claim 6, wherein the controller outputs audio information for outputting audio of the speech when the amount of speech is equal to or greater than a second reference and stops outputting the audio information when the amount of speech is less than the second reference.

10. The method according to claim 9, wherein the controller outputs information for displaying information indicating the speech of the participant when the controller has stopped outputting the audio information.

11. A system comprising a plurality of terminal apparatuses configured to communicate via a server apparatus, wherein
a first terminal apparatus transmits information for generating a 3D model that represents a participant who participates in an event in a virtual space using the first terminal apparatus, and
a second terminal apparatus receives the information from the first terminal apparatus, generates the 3D model to have a size corresponding to an amount of speech of the participant in the event, and outputs information for displaying an image obtained by rendering the virtual space in which the 3D model is placed.

12. The system according to claim 11, wherein the second terminal apparatus generates the 3D model to have a first size for a first amount of speech and to have a second size that is larger than the first size for a second amount of speech that is larger than the first amount of speech.

13. The system according to claim 11, wherein the second terminal apparatus is configured to hide the 3D model in the image when the amount of speech is equal to or less than a first reference.

14. The system according to claim 11, wherein the second terminal apparatus outputs audio information for outputting audio of the speech when the amount of speech is equal to or greater than a second reference and stops outputting the audio information when the amount of speech is less than the second reference.

15. The system according to claim 14, wherein the second terminal apparatus outputs information for displaying information indicating the speech of the participant when the second terminal apparatus has stopped outputting the audio information.
